(19) United States
(12) Patent Application Publication
(10) Pub. No.: US 2026/0171880 A1
(43) Pub. Date: Jun. 18, 2026

(54) MACHINE ASSEMBLY WITH VERTICALLY-SPACED LEVITATION AND AXIAL ADJUSTMENT ACTUATORS

(71) Applicant: SKF CANADA LIMITED, Scarborough (CA)

(72) Inventors: Jeffrey Russell SMITHANIK, Calgary (CA); Tracy Kathryn STREM, Calgary (CA); Mohammed MUSTAFA, Calgary (CA); Jonathan Lee Vivian LESAGE, Calgary (CA); Tanner Doran OSEEN, Calgary (CA)

(21) Appl. No.: 18/980,526

(22) Filed: Dec. 13, 2024

(51) Int. Cl. H02K 21/02; H02K 7/09

(52) U.S. Cl. CPC H02K 21/026; H02K 7/09

(57) ABSTRACT

A machine assembly includes a ferromagnetic annular rotor rotatable about a central vertical axis and configured to support at least one object. A plurality of levitation actuators are spaced circumferentially about the central axis and radially outwardly from the rotor. Each levitation actuator includes a permanent magnet configured to exert an attractive force on the rotor to levitate the rotor above a base surface, the attractive force having a vertical component along the central axis. A plurality of axial adjustment actuators are spaced circumferentially about the central axis and radially outwardly from the rotor. Each axial adjustment actuator includes an electromagnet configured to exert an attractive force on the rotor to adjust the position of the rotor along the central axis, the attractive force of each axial adjustment actuator having a vertical component directed in an opposing axial direction from the vertical component of the levitation actuators attractive force.

### BACKGROUND OF THE INVENTION

The present invention relates to machines having rotor and stator assemblies, and more particularly to machines having magnetically levitated rotors.

In certain industries, such as semiconductor manufacturing, the processing of products or “objects” is often conducted while such objects are rotated about a central axis, such as for example, etching, deposition, photolithography, annealing, etc. Typically, the object(s) are disposed on a central rotor that is surrounded by a stator assembly, which includes motor actuators for applying magnetic torque to the rotor, levitation actuators for magnetically lifting the rotor, radial position actuators for maintaining the rotor centered about the central axis and various axial and radial position sensors. Generally, the levitation actuators include a combination of permanent magnets, which primarily exert a lifting force on the rotor, and electromagnets which adjust the vertical position of the rotor along the central axis.

### SUMMARY OF THE INVENTION

In an aspect, the present invention is a machine assembly for rotating at least one object about a central vertical axis, the assembly comprising an annular rotor formed of a ferromagnetic material, being rotatable about a central vertical axis and configured to support the at least one object. A plurality of levitation actuators are spaced circumferentially about the central vertical axis and radially outwardly from the rotor. Each levitation actuator includes a permanent magnet and is configured to exert an attractive force on the rotor so as to levitate the rotor above a base surface, the attractive force of each levitation actuator having a vertical component along the central vertical axis. A plurality of axial adjustment actuators are spaced circumferentially about the central vertical axis and radially outwardly from the rotor. Each axial adjustment actuator includes an electromagnet and is configured to exert an attractive force on the rotor so as to adjust the position of the rotor along the central vertical axis. The attractive force of each axial adjustment actuator has a vertical component along the central vertical axis directed in an opposing axial direction from the vertical component of the attractive force of each one of the levitation actuators.

Preferably, each one of the permanent magnets of the plurality of levitation actuators has a center and each one of the electromagnets of the plurality of axial adjustment actuators has a center. As used herein, an actuator “center” is defined as the average vertical location of the force-generating faces of the actuator. The center of each electromagnet is preferably located vertically lower than the center of each permanent magnet such that the vertical component of the attractive force of each electromagnet is directed downwardly along the central vertical axis. The levitation actuators and axial adjustment actuators are preferably also spaced circumferentially apart, such that each electromagnet of the axial adjustment actuators is disposed between a separate pair of permanent magnets of the levitation actuators.

Further, the machine assembly preferably comprises a controller configured to vary electric current flow through the electromagnet of one or more of the plurality of axial adjustment actuators so as to adjust the vertical position of the rotor along the central vertical axis. That is, the rotor displaces vertically downwardly along the central vertical axis when electric current through one or more of the electromagnets is increased and the rotor displaces vertically upwardly along the central vertical axis when electric current through one or more of the electromagnets is reduced. Furthermore, the machine assembly further comprises at least one axial position sensor configured to sense a position of the rotor along the central axis and the controller is electrically connected with the at least one axial position sensor and is configured to vary electric current flow through the electromagnet to locate the rotor at a desired vertical position.

### BRIEF DESCRIPTION OF THE SEVERAL VIEWS OF THE DRAWINGS

The foregoing summary, as well as the detailed description of the preferred embodiments of the present invention, will be better understood when read in conjunction with the appended drawings. For the purpose of illustrating the invention, there is shown in the drawings, which are diagrammatic, embodiments that are presently preferred. It should be understood, however, that the present invention is not limited to the precise arrangements and instrumentalities shown. In the drawings:

FIG. 1 is a perspective view of a machine assembly in accordance with the present invention;

FIG. 2 is a top plan view of the machine assembly;

FIG. 3 is an axial cross-sectional view through line 3-3 of FIG. 2;

FIG. 4 is a perspective view of a rotor of the machine assembly, showing a presently preferred construction;

FIG. 5 is an axial cross-sectional view of the rotor of FIG. 4;

FIG. 6 is a perspective view of a stator assembly of the machine assembly, showing a presently preferred construction;

FIG. 7 is a broken-away, enlarged axial cross-sectional view of the machine assembly, showing one levitation actuator and a portion of the rotor;

FIG. 8 is a broken-away, enlarged axial cross-sectional view of the machine assembly, showing one axial adjustment actuator and a portion of the rotor;

FIG. 9 is a broken-away, enlarged axial cross-sectional view of the machine assembly, showing one radial position actuator and a portion of the rotor;

FIG. 10 is a broken-away, enlarged axial cross-sectional view of the machine assembly, showing one radial position sensor and two axial position sensors;

FIG. 11 is another view of the portion of the machine assembly shown in FIG. 7, showing magnetic flux through a permanent magnet of the levitation actuator and a portion of the rotor; and

FIG. 12 is another view of the portion of the machine assembly shown in FIG. 8, showing magnetic flux through an electromagnet of the axial adjustment actuator and a portion of the rotor.

### DETAILED DESCRIPTION OF THE INVENTION

Certain terminology is used in the following description for convenience only and is not limiting. The words “lower”, “upper”, “upward”, “down” and “downward” designate directions in the drawings to which reference is made and the words “inner”, “inwardly” and “outer”, “outwardly” refer to directions toward and away from, respectively, a designated centerline or a geometric center of an element being described, the particular meaning being readily apparent from the context of the description. Further, as used herein, the words “connected” and “coupled” are each intended to include direct connections between two members without any other members interposed therebetween and indirect connections between members in which one or more other members are interposed therebetween. The terminology includes the words specifically mentioned above, derivatives thereof, and words of similar import.

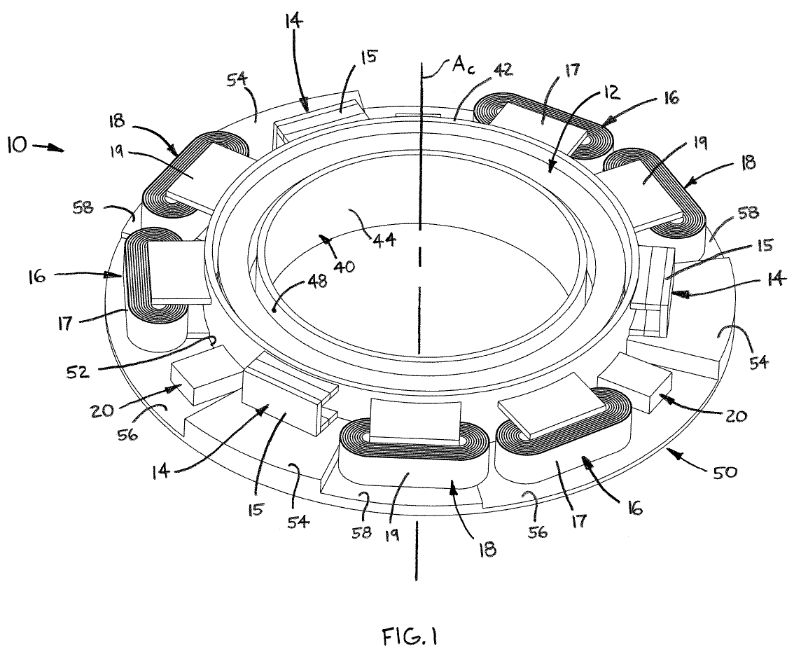

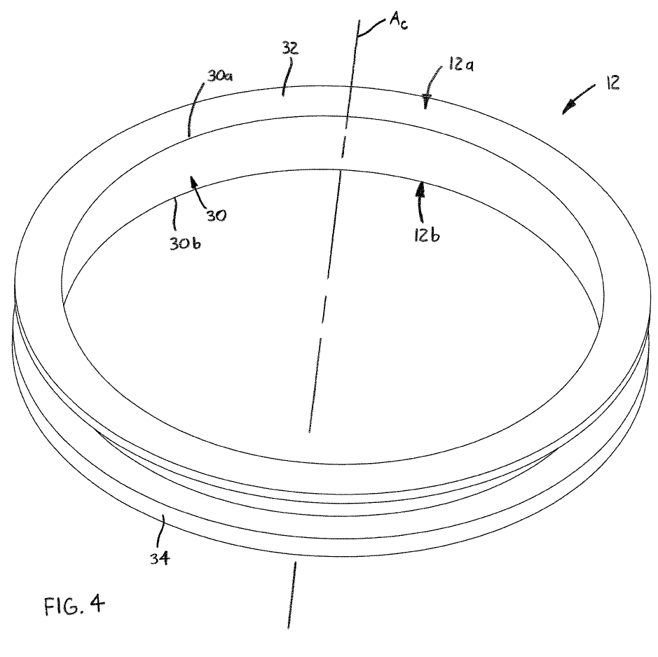

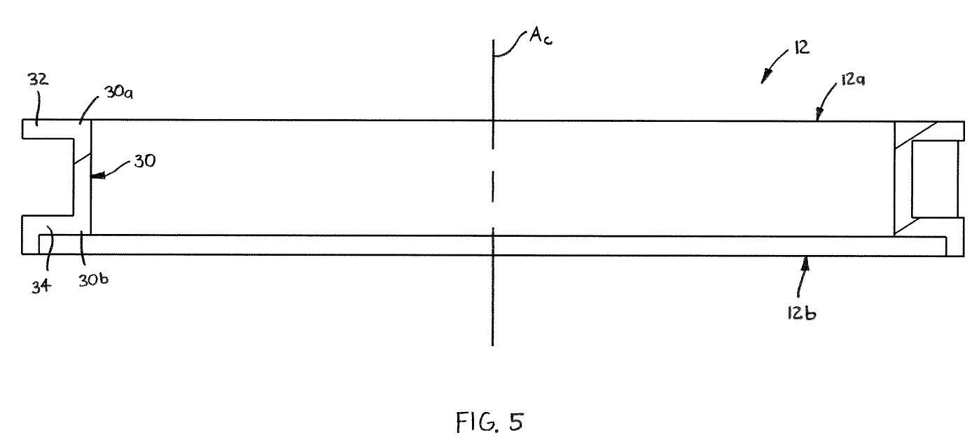

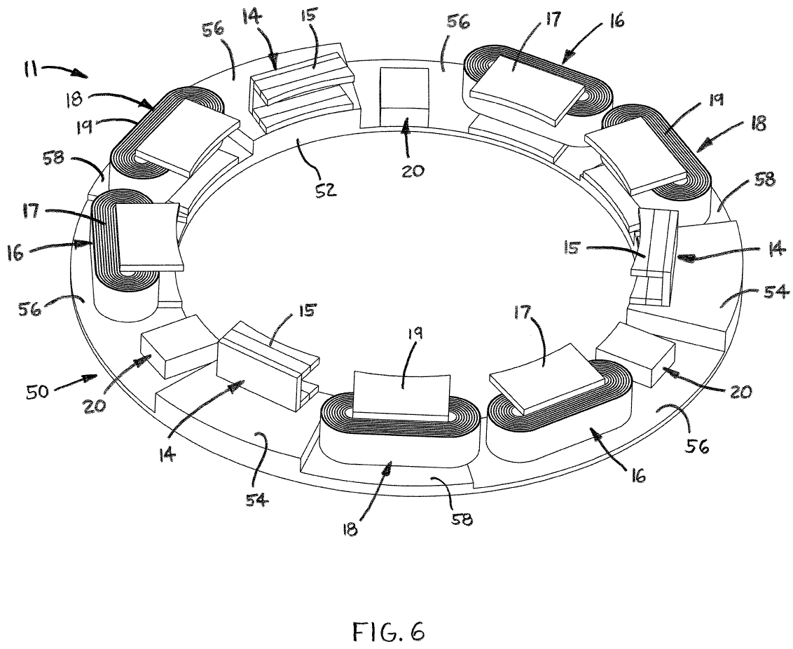

Referring now to the drawings in detail, wherein like numbers are used to indicate like elements throughout, there is shown in FIGS. 1-12 a machine assembly 10 for rotating at least one object (e.g., a semiconductor wafer, none shown) about a central vertical axis A_{C}, particularly in order to process the object(s) using a tool, such as for example, a laser, light, ion accelerator, deposition injector, etc. (none shown). The assembly 10 basically comprises an annular rotor 12 for supporting the object(s), a plurality of permanent magnet levitation actuators 14 for levitating the rotor 12 above a base surface S and a plurality of electromagnetic axial adjustment actuators 16 for adjusting the axial or vertical position of the rotor 12 along the central vertical axis A_{C}, the levitation actuators 14 and axial adjustment actuators 16 being components of a stator assembly 11 (FIG. 6). Preferably, the machine assembly 10 further comprises a plurality of radial position actuators 18, at least one radial position sensor 20, at least one axial position sensor 22, a controller 24 and a plurality of electromagnetic motors (none shown) for angularly displacing the rotor 12 about the central vertical axis A_{C}, which are all incorporated in the stator assembly 11.

More specifically, the rotor 12 has upper and lower axial ends 12a, 12b, is formed of a ferromagnetic material, is rotatable about the central vertical axis A_{C} and is configured to support the one or more objects being processed, either directly on the rotor 12 or by means of a separate holder (none shown) connected with the rotor 12. Preferably, for reasons described below, the rotor 12 includes a central tubular portion 30 with opposing upper and lower axial ends 30a, 30b, respectively, an upper radial flange portion 32 extending radially outwardly from the upper axial end 30a of the tubular portion 30 and a lower radial flange portion 34 extending radially outwardly from the lower axial end 30b of the tubular portion 30. As such, the preferred rotor 12 has generally C-shaped axial cross-sections. However, the rotor 12 may be formed in any appropriate manner or have any appropriate shape, such as for example, generally tubular, as a generally cylindrical disk, etc. Further, while the present disclosure describes and depicts an arrangement in which the rotor 12 is located inside the stator assembly 11, with the rotor 12 having flanges 32, 34 which extend radially outwardly, it is within the scope of the present invention to invert this arrangement such that the stator assembly is located inside the rotor and the rotor flanges extend radially inwardly (alternative not depicted).

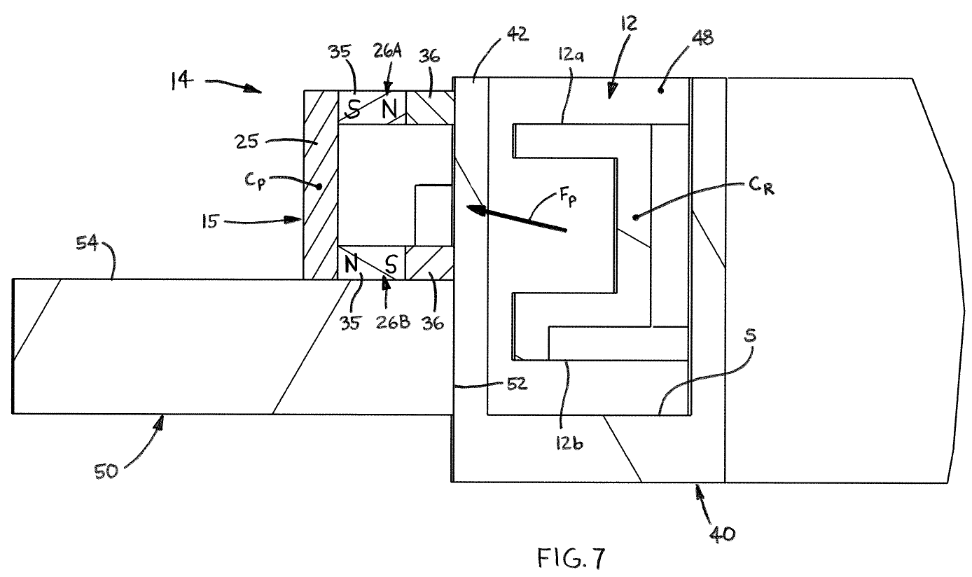

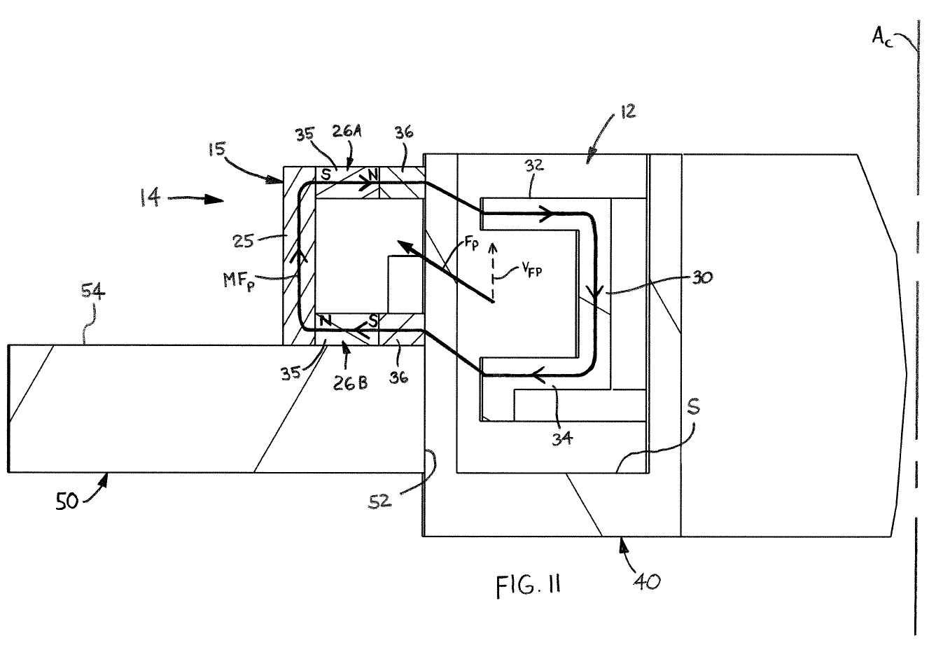

Further, the plurality of levitation actuators 14 are spaced circumferentially about the central vertical axis A_{C} and are preferably spaced radially outwardly from the rotor 12. Each levitation actuator 14 includes a permanent magnet 15 and is configured to exert an attractive force F_{P} on the rotor 12 so as to levitate the rotor 12 above a base surface S, as indicated in FIGS. 7 and 11. The permanent magnets 15 are formed and sized such that the attractive forces F_{P} of all of the permanent magnets 15 collectively have a sufficient magnitude to support the weight of the rotor 12 when no electric current flows through the axial adjustment actuators 16, as described below.

Referring particularly to FIGS. 7 and 11, each permanent magnet 15 is preferably generally C-shaped and includes a vertically-extending central portion 25 and upper and lower flange portions 26A, 26B extending radially inwardly from the central portion 25 and toward the central vertical axis A_{C}. More specifically, the central portion 25 is preferably composed of a ferromagnetic material, such as a mild steel, and the flange portions 26A, 26B are each composed of magnet elements 35, which are formed of a permanent magnet material, such as rare-earth magnet material, and optionally with ferromagnetic material front poles 36 as shown. The permanent magnet elements are preferably arranged with North and South polarities as indicated by “N” and “S” in FIGS. 7 and 11. However, the permanent magnets 15 may each be formed in any other appropriate manner that enables the levitation actuators 14 to function generally as described herein. In any case, due to the simultaneous action of the axial adjustment actuators 16 on the rotor 12, the attractive force F_{P} of each levitation actuator 14 has a vertical component v_{FP} along the central vertical axis A_{C}, as depicted in FIG. 11.

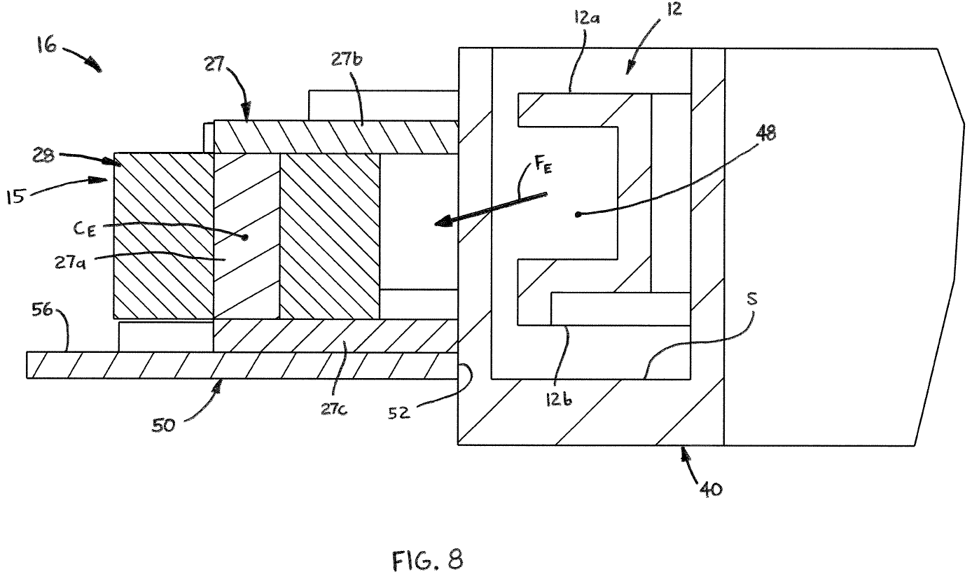

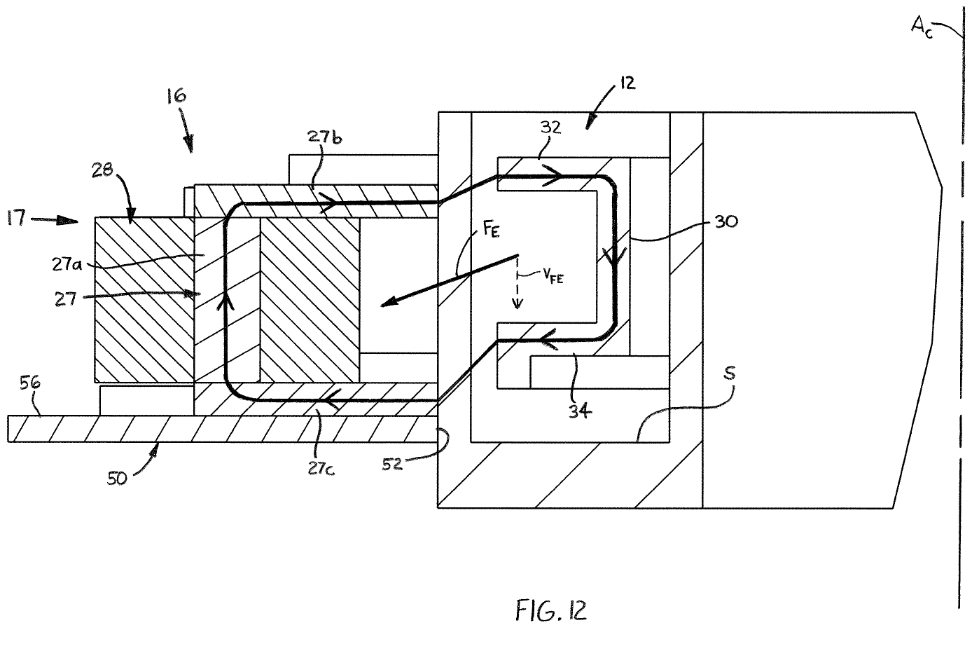

Furthermore, the plurality of axial adjustment actuators 16 are spaced circumferentially about the central vertical axis A_{C} and are spaced radially outwardly from the rotor 12. Each axial adjustment actuator 16 includes an electromagnet 17 and is configured to exert an attractive force F_{E} on the rotor 12 so as to adjust the position of the rotor 12 along the central vertical axis A_{C}, as depicted in FIGS. 8 and 12. Preferably, each electromagnet 17 includes a core 27 with a vertically-extending central portion 27a and upper and lower flange portions 27b, 27c, respectively, extending radially inwardly from the central portion 27a and toward the central vertical axis A_{C}, and a winding or coil 28 wrapped around the central portion 27a of the core 27, as shown in FIGS. 8 and 12. However, as with the permanent magnets 15, the electromagnets 17 may each be formed in any other appropriate manner that enables the axial adjustment actuators 16 to operate generally as discussed herein.

Due the preferred relative positioning of the actuators 14, 16 as described in further detail below, the attractive force F_{E} of each axial adjustment actuator 16 has a vertical component v_{FE} (FIG. 12) along the central vertical axis A_{C} directed in an opposing axial direction from the vertical component v_{FP} (FIG. 11) of the attractive force F_{P} of each one of the levitation actuators 14. Thus, the levitation actuators 14 function to maintain the rotor 12 spaced above the base surface S in a “floating” state whereas the axial adjustment actuators 16 act against the attractive force F_{P} applied by the levitation actuators 14 in order to position the rotor 12 at a specific or desired axial location along the central vertical axis A_{C}.

Referring to FIGS. 1, 2 and 6, the actuators 14, 16 are arranged such that each one of the plurality of axial adjustment actuators 16 is spaced circumferentially apart from each one of the plurality of levitation actuators 14, such that each electromagnet 17 is disposed circumferentially between a separate pair of adjacent permanent magnets 15. Thus, the two types of actuators 14, 16 are spaced apart or spatially separated in order to prevent interference between the magnetic flux MF_{P}, MF_{E} (FIGS. 11 and 12) generated by each one of the permanent magnets 15 and the electromagnets 17, respectively, which may otherwise require increased current through the electromagnets 17 in order to apply a desired magnitude of the attractive force F_{E}.

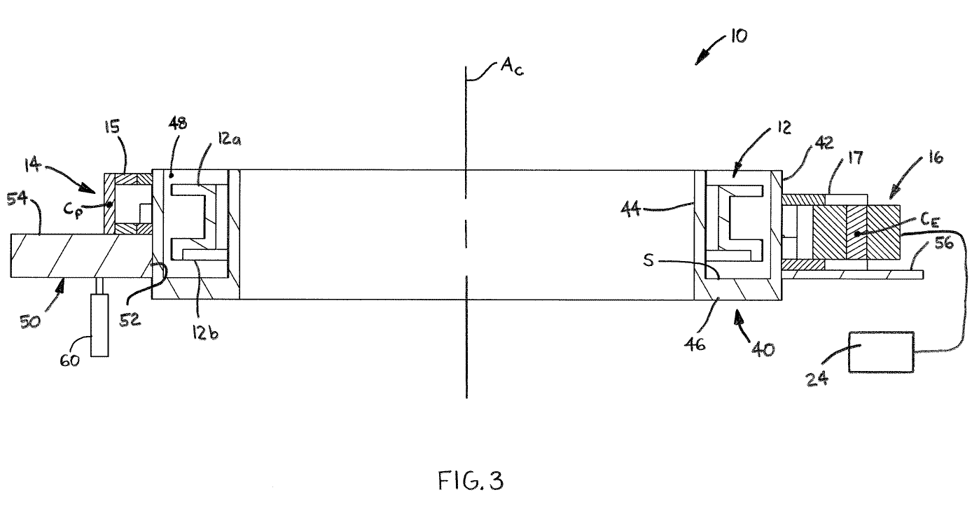

Perhaps more significantly, the two types of actuators 14, 16 are spaced or separated vertically in order to produce the desired combined effect on the vertical position of the rotor 12 as described above. Specifically, each one of the permanent magnets 15 of the levitation actuators 14 has a center C_{P} and each one of the electromagnets 17 of the axial adjustment actuators 17 has a center C_{E}, as indicated in FIGS. 3, 7 and 8, where C_{P} and C_{E} can be considered as the average vertical position of the magnetic pole faces of the actuators 14, 16, respectively. The rotor 12 likewise has a center C_{R} (FIGS. 7 and 8), which can be considered as the average vertical position of the circumferential magnetic pole faces of the rotor flanges 32, 34. The centers C_{P}, C_{E} of the two sets of actuators 14, 16 are spaced apart vertically in order to apply attractive forces F_{P}, F_{E} having respective vertical components v_{FP}, v_{FE} which preferably extend in opposing directions along the central vertical axis A_{C}, as best shown in FIGS. 11 and 12.

Preferably, the center C_{E} of each electromagnet 17 is located vertically lower than the center C_{P} of each permanent magnet 15, as well as vertically lower than the rotor center C_{R}, such that the vertical component v_{FE} of the attractive force F_{E} of each electromagnet 17 is directed downwardly along the central vertical axis A_{C}. Most preferably, the center C_{P} of each permanent magnet 15 of the plurality of levitation actuators 14 is located vertically higher than the rotor center C_{R}, with at least a portion of each permanent magnet 15 of the plurality of levitation actuators 14 located vertically above the upper axial end 12a of the rotor 12 and at least a portion of each electromagnet 17 of the plurality of axial adjustment actuators 16 located vertically below the lower axial end 12b of the rotor 12. Alternatively, the axial adjustment actuators 16 may be spaced vertically above the levitation actuators 14 such that attractive forces F_{E} applied to the rotor 12 by the axial adjustment actuators 16 is cumulative to the attractive forces F_{P} applied by the levitation actuators 16. As such, the axial adjustment actuators 16 pull the rotor 12 further upwardly from the vertical position along the central axis A_{C} established by the attractive forces F_{P} of all of the levitation actuators 14.

In the preferred arrangement described above, the permanent magnets 15 of the levitation actuators 14 pull upwardly on the rotor 12 in order to levitate the rotor 12 while the electromagnets 17 of the axial adjustment actuators 16 pull downwardly on the rotor 12 in order to “fine tune” the axial position of the rotor 12 to a specific, desired vertical location on the central vertical axis A_{C}, and to control or dampen vibrations in the rotor 12 which may arise from rotational unbalance forces, process loads or other disturbances. More specifically, with the preferred structure of the rotor 12 and the positioning of the permanent magnets 15 and the electromagnets 17, magnetic flux MF_{P}, MF_{E} generated by the magnets 15 or 17, respectively, passes through the rotor 12 and results in the attractive forces F_{P} and F_{E} being applied to the rotor 12 as follows.

Referring particularly to FIG. 11, with the preferred structure of each permanent magnet 15, magnetic flux MF_{P} circulates radially outwardly from the lower flange portion 26B, upwardly through the central portion 25, radially inwardly through the upper flange portion 26A, radially inwardly through the upper flange portion 32 of the rotor 12, downwardly through the rotor tubular portion 30, radially outwardly through the rotor lower flange portion 34 and back into the lower flange portion 26B of the permanent magnet 15. As a result of this flux path, the relative positioning of each permanent magnet 15 with respect to each electromagnet 17 and the counteracting effect of the attractive force F_{E} of the electromagnets 17, the attractive force F_{P} of each permanent magnet 15 extends diagonally upwardly from the rotor 12 toward each permanent magnet 15 and provides a vertical component v_{FP} that is directed vertically upwardly, as indicated in FIG. 11.

Now referring specifically to FIG. 12, with the preferred structure of each electromagnet 17, magnetic flux MF_{E} circulates radially outwardly from the core lower flange portion 27c, upwardly through the core central portion 27a, radially inwardly through the core upper flange portion 27b, radially inwardly through the upper flange portion 32 of the rotor 12, downwardly through the rotor tubular portion 30, radially outwardly through the rotor lower flange portion 34 and back into the core lower flange portion 27b of the electromagnet 17. Due to this specific flux path, the relative vertical positioning of each electromagnet 17 with respect to each permanent magnet 15 and the counteracting effect of the attractive force F_{P} of the permanent magnets 15, the attractive force F_{E} of each electromagnet 17 extends diagonally downwardly from the rotor 12 toward each electromagnet 17 and provides a vertical component v_{FE} that is directed vertically downwardly, as indicated in FIG. 12.

Although the above-described arrangement of the permanent magnets 15 and electromagnets 17 is presently preferred, the levitation actuators 14 and the axial adjustment actuators 16 may be alternatively arranged such that the centers C_{E} of the electromagnets 17 are located vertically above the centers C_{P} of the permanent magnets 15. In such an arrangement of the actuators 14, 16, the attractive force F_{E} of the electromagnets 17 may operate to pull upwardly against the attractive force F_{P} of the permanent magnets 15.

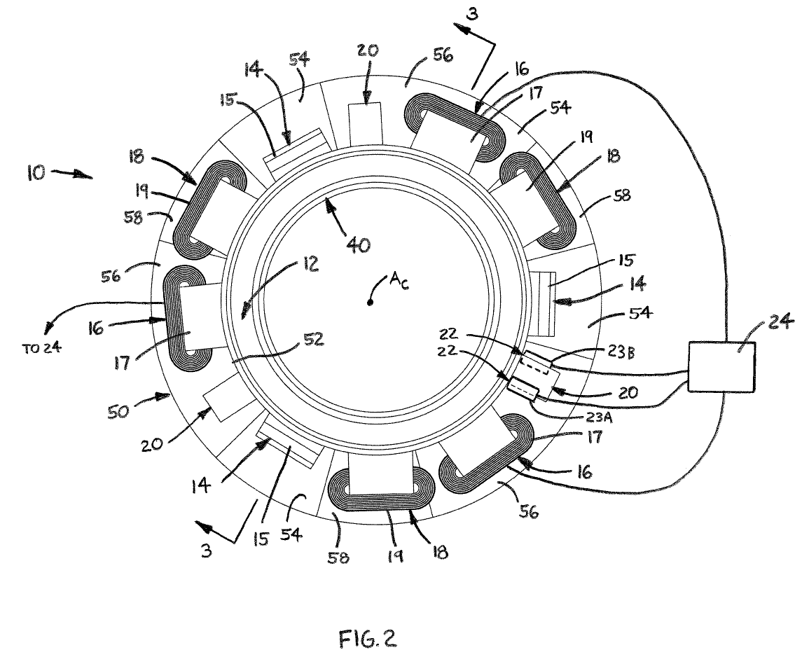

Referring now to FIGS. 2 and 3, as mentioned above, the machine assembly 10 preferably further comprises a controller 24 configured to vary electric current flow through the electromagnets 17 of the axial adjustment actuators 16. That is, to adjust the vertical position of the rotor 12 along the central vertical axis A_{C}, the controller 24 varies the current through one or more of the electromagnets 17 of the plurality of axial adjustment actuators 15, preferably through all of the electromagnets 17 simultaneously, until the rotor 12 is located at the desired vertical position. More specifically, in the preferred arrangement described above, the rotor 12 displaces vertically downwardly along the central vertical axis A_{C} when electric current through one or more of the electromagnets 17 is increased and the rotor 12 alternatively displaces vertically upwardly along the central vertical axis A_{C} when electric current through one or more of the electromagnets 17 is reduced. Alternatively, if the axial adjustment actuators 16 were positioned above the levitation actuators 14, an increase in electric current through the electromagnets 17 displaces the rotor 14 upwardly, and vice-versa.

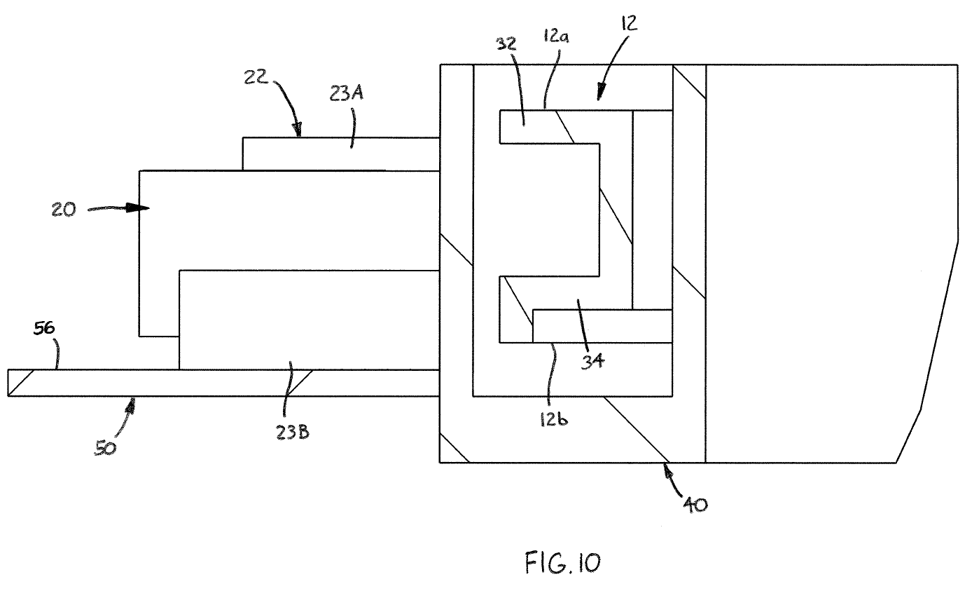

Referring to FIGS. 2 and 10, the one or more axial position sensors 22 are configured to sense the vertical position of the rotor 12 along the central axis A_{C} and the controller 24 is electrically connected with the axial position sensor(s) 22. As such, the controller 24 is capable of adjusting current through the electromagnets 17 of the axial adjustment actuators 16 in order to either maintain the rotor 12 at a specific vertical position during the entire duration of a processing operation of the assembly 10 or to displace the rotor 12 between multiple different vertical positions required during a processing operation. In either case, the controller 24 is preferably programmed or otherwise configured to operate the axial adjustment actuators 16 to ensure that the rotor 12 is located at the one or more specific, desired vertical positions, relative to the stator assembly 11, during the operation of the machine assembly 10. Preferably, the machine assembly 10 includes an upper axial position sensor 23A configured to detect the upper flange portion 32 of the rotor 12 and a lower axial position sensor 23B configured to detect the lower flange portion 34, but the one or more axial position sensors 22 may be formed in any other appropriate manner and may “observe” or detect other appropriate flanges, edges or features on the rotor 12.

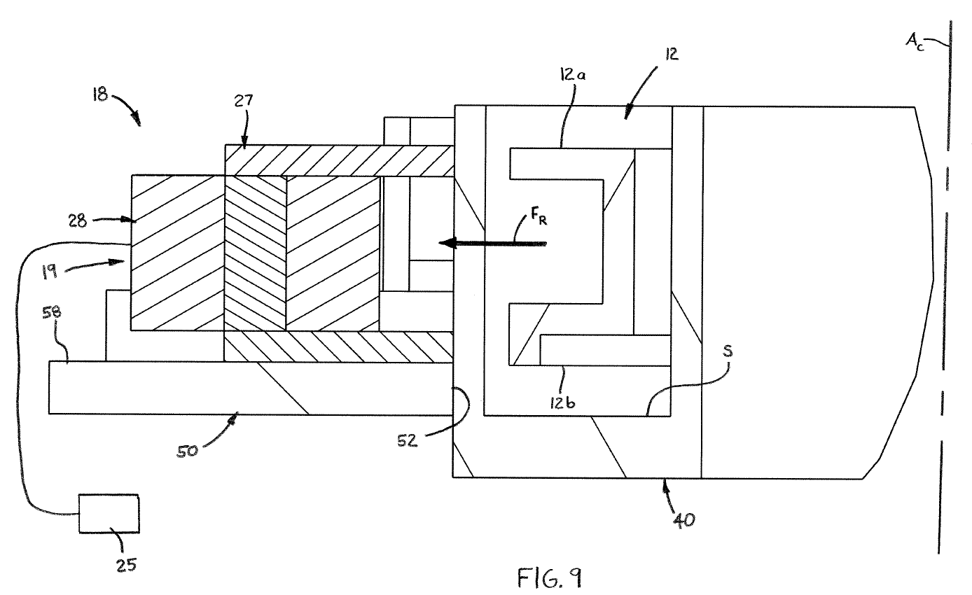

Referring to FIGS. 1, 2 and 9, as discussed above, the machine assembly 10 preferably comprises a plurality of electromagnetic radial position actuators 18 spaced circumferentially about the central vertical axis A_{C} and radially outwardly from the rotor 12. Each radial position actuator 18 is configured to exert an attractive force F_{R} on the rotor 12, which extends radially with respect to the central vertical axis A_{C}, as indicated in FIG. 9. As such, with the radial position actuators 18 being circumferentially spaced around the rotor 12, varying the magnitude of the attractive force F_{R} within the various radial position actuators 18 adjusts the radial position of the rotor 12 with respect to the central axis A_{C}. Specifically, the radial position actuators 18 operate to ensure that the geometric center (not indicated) of the rotor 12 remains located on the central vertical axis A_{C}. Preferably, each radial position actuator 18 includes an electromagnet 19 formed generally identical to the electromagnets 17 of the axial adjustment actuators 16, specifically with a C-shaped core 27 and a coil/winding 28, but is positioned vertically centered with respect to the rotor 12 such that the attractive force F_{R} extends substantially radially. However, the radial position actuators 18 may each be formed in any other appropriate manner.

In order to properly operate the radial position actuators 18, the machine assembly includes one or more radial position sensors 20 configured to sense the radial position of the rotor 12 with respect to the central axis A_{C} and a controller electrically connected with the radial positions sensors 20 and with the plurality of radial position actuators 18. The controller is configured to adjust the electric current through the radial position actuators 18 to “center” the rotor 12 on the central vertical axis A_{C} when the radial position sensors 20 determine that the geometric center of the rotor 12 has displaced radially with respect to the central axis A_{C}. The controller for operating the radial position actuators 18 may be the controller 24 as described above or may be another separate controller 25, as indicated in FIG. 9.

Referring now to FIGS. 1-3, 7 and 8, in a presently preferred application of the machine assembly 10, it is desired to isolate the rotor 12 from the various actuators 14, 16, 18 and sensors 20, 22, etc., in order to both prevent damage to the stator components from process fluids or materials and to prevent contamination of the object(s) being processed. As such, the machine assembly 10 preferably further comprises a nonmagnetic enclosure 40 including a tubular wall 42 encircling the rotor 12 and disposed radially between the rotor 12 and the plurality of levitation actuators 14, radially between the rotor 12 and the plurality of axial adjustment actuators 16, as well as radially separating the other actuators 18 and sensors 20, 22 described above from the rotor 12. Preferably, the enclosure 40 further includes an inner tubular wall 44 spaced radially inwardly from the tubular wall 42 and an annular base wall 46 extending between and integrally formed with the tubular walls 42, 44.

As such, the enclosure 40 provides an annular process chamber 48 within which the rotor 12 is disposed and the base wall 46 provides the base surface S above which the rotor 12 is levitated. The annular process chamber 48 enables the processing of an object(s) disposed on the rotor 12 with chemicals that may damage the various actuators 14, 16, and 18 and sensors 20, 22, etc. However, the enclosure 40 may be formed in any other appropriate manner, such as for example, including only the outer tubular wall 42 with the base surface S being provided by a floor or other surface on which the machine assembly 10 is located. Further, the enclosure 40 is preferably formed of austenitic stainless steel, but may be formed of any other appropriate nonmagnetic material. Further, the enclosure 40 may be formed substantially “taller” (i.e., with a greater vertical height or dimension) than either the stator assembly 11 or the rotor 12. Such a relatively greater height of the enclosure 40 allows the stator assembly 11 to be adjustably located at various desired vertical positions along the central vertical axis A_{C} by means of an appropriate lifting device(s) 60 (FIG. 3), such as for example, one or more power screws, a rack and pinion device(s), etc., with the controller 24 maintaining the axial position of the rotor 12 relative to the stator assembly 11 during vertical displacement of the stator assembly 11.

Referring to FIGS. 1-3, the machine assembly 10 preferably further comprises an annular housing 50 having a central bore 52 and including a plurality of upper support surfaces 54 spaced circumferentially about the central vertical axis A_{C} and a plurality of lower support surfaces 56 spaced circumferentially about the central vertical axis A_{C}, the upper and lower support surfaces 54, 56 alternating circumferentially about the central axis A_{C}. The enclosure 40, and thus also the rotor 12, is disposed within the central bore 52, each one of the plurality of levitation actuators 14 is disposed on a separate one of the plurality of upper support surfaces 54 and each one of the plurality of axial adjustment actuators 16 is disposed on a separate one of the plurality of lower support surfaces 56. As such, the support surfaces 54, 56 establish the relative vertical spacing between the actuators 14 and 16 as described in detail above.

Further, with the preferred radial position actuators 18, the annular housing 50 also preferably includes a plurality of intermediate support surfaces 58 spaced circumferentially about the central vertical axis A_{C}. Each intermediate support surface 58 is disposed circumferentially between one upper support surface 54 and one lower support surface 56, and a separate one of the plurality of radial position actuators 18 is disposed upon a separate one of the intermediate support surfaces 58. The relative height of the intermediate support surface 58 positions the radial position sensors 18 to pull substantially radially on the rotor 12, i.e., without any vertical component to the attractive force F_{R} of the radial actuators 16.

Although the housing 50 is preferably formed as described above, the housing 50 may be formed in any other appropriate manner. For example, instead of a series of alternating support surfaces, the housing 50 may includes a plurality of separate frames (none shown) which position the various actuators 14, 16, 18 and sensors 20, 22, etc. at desired vertical and radial positions with respect to the rotor 12.

Representative, non-limiting examples of the present invention were described above in detail with reference to the attached drawings. This detailed description is merely intended to teach a person of skill in the art further details for practicing preferred aspects of the present teachings and is not intended to limit the scope of the invention.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter. The invention is not restricted to the above-described embodiments, and may be varied within the scope of the following claims.

We claim:

1. A machine assembly for rotating at least one object about a central vertical axis, the machine assembly comprising:
an annular rotor formed of a ferromagnetic material, being rotatable about a central vertical axis and configured to support the at least one object;
a plurality of levitation actuators spaced circumferentially about the central vertical axis and radially outwardly from the rotor, each levitation actuator including a permanent magnet and being configured to exert an attractive force on the rotor so as to levitate the rotor above a base surface, the attractive force of each levitation actuator having a vertical component along the central vertical axis; and
a plurality of axial adjustment actuators spaced circumferentially about the central vertical axis and radially outwardly from the rotor, each axial adjustment actuator including an electromagnet and being configured to exert an attractive force on the rotor so as to adjust the position of the rotor along the central vertical axis, the attractive force of each axial adjustment actuator having a vertical component along the central vertical axis directed in a same axial direction or an opposing axial direction from the vertical component of the attractive force of each one of the levitation actuators.

2. The machine assembly as recited in claim 1, wherein each one of the permanent magnets of the plurality of levitation actuators has a center and each one of the electromagnets of the plurality of axial adjustment actuators has a center, the center of each electromagnet being located vertically lower than the center of each permanent magnet such that the vertical component of the attractive force of each electromagnet is directed downwardly along the central vertical axis.

3. The machine assembly as recited in claim 1, further comprising a controller configured to vary electric current flow through the electromagnet of one or more of the plurality of axial adjustment actuators so as to adjust the vertical position of the rotor along the central vertical axis.

4. The machine assembly as recited in claim 3, wherein:
the rotor displaces vertically downwardly along the central vertical axis when electric current through one or more of the electromagnets is increased; and
the rotor displaces vertically upwardly along the central vertical axis when electric current through one or more of the electromagnets is reduced.

5. The machine assembly as recited in claim 1, further comprising:
at least one axial position sensor configured to sense a position of the rotor along the central axis; and
a controller electrically connected with the at least one axial position sensor and configured to vary electric current flow through the electromagnet of one or more of the plurality of axial adjustment actuators to adjust a position of the rotor along the central vertical axis.

6. The machine assembly as recited in claim 1, wherein each one of the plurality of axial adjustment actuators is spaced circumferentially apart from each one of the plurality of levitation actuators such that each electromagnet is disposed circumferentially between a separate pair of adjacent permanent magnets.

7. The machine assembly as recited in claim 1, further comprising:
a plurality of electromagnetic radial position actuators spaced circumferentially about the central vertical axis and radially outwardly from the rotor, each radial position actuator being configured to exert an attractive force on the rotor, the attractive force of each electromagnetic radial position actuator extending radially with respect to the central vertical axis; and
a controller configured to adjust current through the plurality of electromagnetic radial position actuators so as to adjust a radial position of the rotor with respect to the central vertical axis.

8. The machine assembly as recited in claim 1, further comprising a nonmagnetic enclosure including a tubular wall encircling the rotor and disposed radially between the rotor and the plurality of levitation actuators and radially between the rotor and the plurality of axial adjustment actuators.

9. The machine assembly as recited in claim 1, further comprising an annular housing having a central bore, the rotor being disposed within the central bore, a plurality of upper support surfaces spaced circumferentially about the central vertical axis and a plurality of lower support surfaces spaced circumferentially about the central vertical axis, each one of the plurality of levitation actuators being disposed on a separate one of the plurality of upper support surfaces and each one of the plurality of axial adjustment actuators being disposed on a separate one of the plurality of lower support surfaces.

10. The machine assembly as recited in claim 9, further comprising at least one lifting device configured to vertically displace the annular housing along the central vertical axis so as to adjust the axial position of the levitation actuators and the axial position of the axial adjustment actuators along the central vertical axis.

11. The machine assembly as recited in claim 1, wherein the rotor has upper and lower axial ends, at least a portion of each permanent magnet of the plurality of levitation actuators is located vertically above the upper axial end of the rotor and at least a portion of each electromagnet of the plurality of axial adjustment actuators is located vertically below the lower axial end of the rotor.

12. The machine assembly as recited in claim 1, wherein the rotor has a weight and the attractive forces of the permanent magnets of the plurality of levitation actuators collectively have a sufficient magnitude to support the weight of the rotor when no electric current flows through the plurality of electromagnets of the axial adjustment actuators.

13. A machine assembly for processing at least one object during rotation, the machine assembly comprising:
an annular rotor formed of a ferromagnetic material, being rotatable about a central vertical axis and configured to support the at least one object;
a plurality of permanent magnets spaced circumferentially about the central vertical axis and radially outwardly from the rotor, each permanent magnet having a center and being configured to exert an attractive force on the rotor, the attractive force of each permanent magnet having a vertical component along the central vertical axis; and
a plurality of electromagnets spaced circumferentially about the central vertical axis and radially outwardly from the rotor, each electromagnet having a center and being configured to exert an attractive force on the rotor, the centers of the plurality of electromagnets being spaced vertically lower than and circumferentially apart from the centers of the plurality of the permanent magnets such that the attractive force of each electromagnet has a vertical component directed downwardly along the central vertical axis while a vertical component of the attractive force of each permanent magnet extends upwardly along the central vertical axis.

14. The machine assembly as recited in claim 13, further comprising a controller configured to vary electric current flow through the electromagnet of one or more of the plurality of axial adjustment actuators so as to adjust the vertical position of the rotor along the central vertical axis.

15. The machine assembly as recited in claim 13, wherein:
the rotor displaces vertically downwardly along the central vertical axis when electric current through one or more of the electromagnets is increased; and
the rotor displaces vertically upwardly along the central vertical axis when electric current through one or more of the electromagnets is reduced.

16. The machine assembly as recited in claim 13, further comprising:
at least one axial position sensor configured to sense a position of the rotor along the central axis; and
a controller electrically connected with the at least one axial position sensor and configured to vary electric current flow through the electromagnet of one or more of the plurality of axial adjustment actuators to adjust a position of the rotor along the central vertical axis.

17. The machine assembly as recited in claim 13, further comprising:
a plurality of electromagnetic radial position actuators spaced circumferentially about the central vertical axis and radially outwardly from the rotor, each radial position actuator being configured to exert an attractive force on the rotor, the attractive force of each electromagnetic radial position actuator extending radially with respect to the central vertical axis; and
a controller configured to adjust current through the plurality of electromagnetic radial position actuators so as to adjust a radial position of the rotor with respect to the central vertical axis.

18. The machine assembly as recited in claim 13, further comprising a nonmagnetic enclosure including a tubular wall encircling the rotor and disposed radially between the rotor and the plurality of levitation actuators and radially between the rotor and the plurality of axial adjustment actuators.

19. The machine assembly as recited in claim 13, further comprising an annular housing having a central bore, the rotor being disposed within the central bore, a plurality of upper support surfaces spaced circumferentially about the central vertical axis and a plurality of lower support surfaces spaced circumferentially about the central vertical axis, each one of the plurality of levitation actuators being disposed on a separate one of the plurality of upper support surfaces and each one of the plurality of axial adjustment actuators being disposed on a separate one of the plurality of lower support surfaces.

20. The machine assembly as recited in claim 13, wherein the rotor has upper and lower axial ends, at least a portion of each permanent magnet of the plurality of levitation actuators is located vertically above the upper axial end of the rotor and at least a portion of each electromagnet of the plurality of axial adjustment actuators is located vertically below the lower axial end of the rotor.
